(19) United States
(12) Patent Application Publication
(10) Pub. No.: US 2006/0290785 A1
(43) Pub. Date: Dec. 28, 2006

(54) Image Capturing Apparatus with a Remote Controller

(76) Inventors: Kuan-Chih Chen, Taipei City (TW); Huai-Tien Kuo, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,747

(22) Filed: Dec. 5, 2005

(30) Foreign Application Priority Data
Jun. 27, 2005 (TW) 094121448

(51) Int. Cl. H04N 5/232

(52) U.S. Cl. 348/211.99

(57) ABSTRACT

An image capturing apparatus includes a remote controller and an image capturing device. The remote controller is capable of controlling the image capturing device remotely to adjust a shoot angle of a lens so that a user is not required to walk up and down between a shoot location and the image capturing device to adjust a required angle of the shoot location shown in the image capturing device. Hence, the image capturing apparatus can overcome inconvenience for the user who wants to shoot photos remotely.

### BACKGROUND OF THE INVENTION

1. Field of the Invention

The present invention relates to an image capturing apparatus, more particularly, an image capturing apparatus capable of remotely adjusting a shoot angle of a lens.

2. Description of the Prior Art

For a general camera with a remote controller, whether it is a digital camera or a traditional camera, the function provided by the remote controller is already familiar to most users, for example: activating a camera shutter, adjusting a camera diaphragm, lens zoom, and so on. The user can control the camera for taking pictures by utilizing a remote controller within a limited distance. In the US Patent Application #20040189850 “Digital camera with detachable display module,” the application teaches that the display module is independent from the image capturing device and installed on the remote controller so that the user can view the picture taken by the image capturing device via the display module from a distance away. Please refer to FIG. 1 and FIG. 2. FIG. 1 illustrates an external view of a conventional image capturing apparatus 10. FIG. 2 illustrates a functional block diagram of a conventional image capturing apparatus 10. An image capturing apparatus 10 can be a digital camera, and the image capturing apparatus 10 includes a remote controller 12 having a first housing 14, an input interface 16 installed within the first housing 14 for inputting a remote control instruction, a first signal transmission module 18 installed within the first housing 14 for outputting a remote control signal, and a first control module 20 installed within the first housing 14 for controlling the first signal transmission module 18 to output the remote control signal when the input interface 16 receives the remote control instruction. The image capturing apparatus 10 further includes an image capturing device 22 which is a main component of the image capturing apparatus 10 for performing the function of taking pictures, the image capturing device 22 has a second housing 24, a lens 26 installed within the second housing 24 for capturing light signals of an image, and an image detector 28 for converting the received light signals into electric signals. If there are more light accepted pixels of the image detector 28, then the resolution of the taken picture will be higher. The image detector 28 has a plurality of charge coupled devices (CCDs) or a plurality of complementary metal-oxide semi-conductors (CMOSs). The image capturing device 22 further has a second signal transmission module 30 installed within the second housing 24 for receiving the remote control signal transmitted from the first signal transmission module 18 of the remote controller 12, and a second control module 32 installed within the second housing 24 which can be a digital signal processor for processing taken image signals, furthermore the second control module 32 can control the operations of the image capturing device 22 according to the remote control signal transmitted from the first signal transmission module 18 to the second signal transmission module 30. The image capturing device 22 further has a memory module 34 can be a flash memory such as a CF card and an SD card, and a read-only memory such as a compact disc and a mini hard-disk for storing taken pictures. Furthermore, the remote controller 12 further has a display module 36 installed on the first housing 14 and electrically connected to the first control module 20, wherein the second control module 32 can control the second signal transmission module 30 to output image signals to the first signal transmission 18, and the display module 36 is utilized for displaying the image signals received by the first signal transmission module 18. The display module 36 can be a TN-LCD, an STN-LCD, a TFT-LCD and an LTPS TFT-LCD.

When the user wants to utilize the image capturing apparatus 10 to shoot a picture, especially when the image capturing device 22 is placed on a stand and the remote controller 12 of the image capturing apparatus 10 at another end, the user can utilize the input interface 16 of the remote controller 12 to input the corresponding remote control instruction, and the first control module 20 can control the first signal transmission module 20 to output the corresponding remote control signal to the second signal transmission module 30 of the image capturing device 22 according to the corresponding remote control instruction inputted by the input interface 16 to control the image capturing device 22 so as to take a picture; furthermore, the image capturing device 22 can also transmit image data captured by the lens 26 via the second signal transmission module 30 to the first signal transmission module 20 of the remote controller 12, and the first control module 20 of the remote controller 12 will control the display module 36 to display the image signal received by the first signal transmission module 20. Therefore, the user can deliberate the image displayed on the display module 36 on the remote controller 12 and utilize the input interface 16 to control the image capturing device 22 to shoot a picture.

When the user previews the image captured by the image capturing device 22 and displayed on the display module 36 of the remote controller 12, and if the user is not satisfied with a shoot angle of the lens; for example, the user discovered that the view should be leaning slightly towards the left or the right, then the user needs to return to where the image capturing device 22 is placed to adjust the location of the image capturing device 22 and then back to the spot where the user was originally. Then if the user is not satisfied with the shoot angle of the image capturing device 22 again, the user will need to return to where the image capturing device 22 is placed and re-adjust the location of the image capturing device 22 again, hence this creates inconvenience for the user wanting to shoot pictures remotely.

### SUMMARY OF THE INVENTION

The claimed invention provides an image capturing apparatus capable of adjusting a shoot angle of a lens remotely to solve the above-mentioned problem.

The claimed invention discloses an image capturing apparatus including a remote controller and an image capturing device. The remote controller includes a first housing, an input interface installed on the first housing for inputting a remote control instruction, a first signal transmission module installed within the first housing for outputting a remote control signal, and a first control module installed within the first housing for controlling the first signal transmission module to output a corresponding remote control signal when the input interface received the remote control instruction. The image capturing device includes a second housing, a lens installed within the second housing for capturing image, a second signal transmission module installed within the second housing for receiving the remote control signal transmitted from the first signal transmission module of the remote controller, a driving module installed within the second housing for driving the image capturing device to adjust a shoot angle of the lens, and a second control module installed within the second housing for controlling operation of the image capturing device according to the remote control signal transmitted from the first signal transmission module and received by the second signal transmission module. The second control module has a logic unit for controlling the driving module to drive the image capturing device to move so as to adjust the shoot angle of the lens when the second signal transmission module receives the remote control signal transmitted from the first signal transmission module.

The claimed invention further discloses a remote controller including a housing, an input interface installed on the housing for inputting a remote control instruction, a signal transmission module installed within the housing for outputting a remote control signal, and a control module installed within the housing for controlling the signal transmission module to output a corresponding remote control signal to control an image capturing device coupled to the remote controller when the input interface receives the remote control instruction. The control module has a logic unit for outputting the remote control signal to control a driving module of the image capturing device to drive the image capturing device to move.

Furthermore, the claimed invention discloses another image capturing device including a housing, a lens installed within the housing for capturing an image, a signal transmission module installed within the housing for receiving a remote control signal in a wireless manner, a driving module installed within the housing for driving the image capturing device to adjust a shoot angle of the lens, and a control module installed within the housing for controlling operation of the image capturing device according to the remote control signal received by the signal transmission module. The control module has a logic unit for controlling the driving module to drive the image capturing device to move so as to adjust a shoot angle of the lens when the signal transmission module receives the remote control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an external view of a conventional image capturing apparatus.

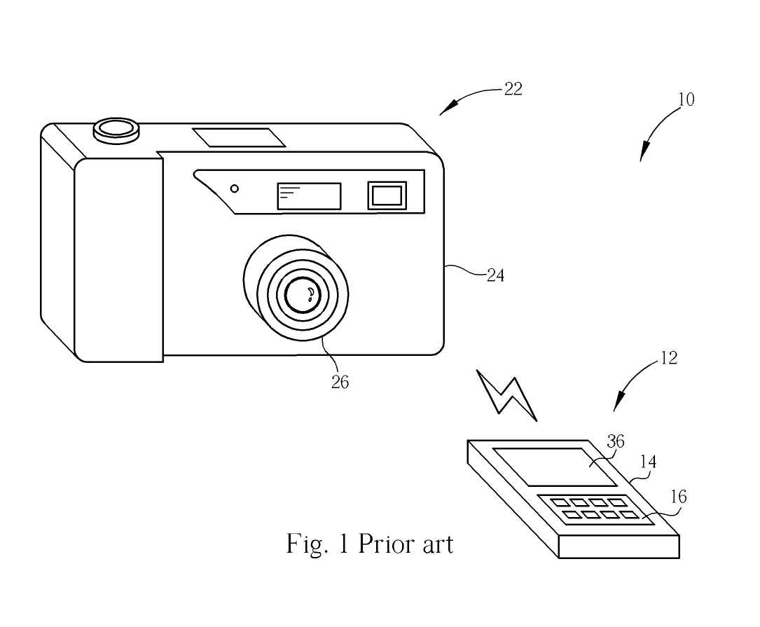

FIG. 2 illustrates a functional block diagram of a conventional image capturing apparatus.

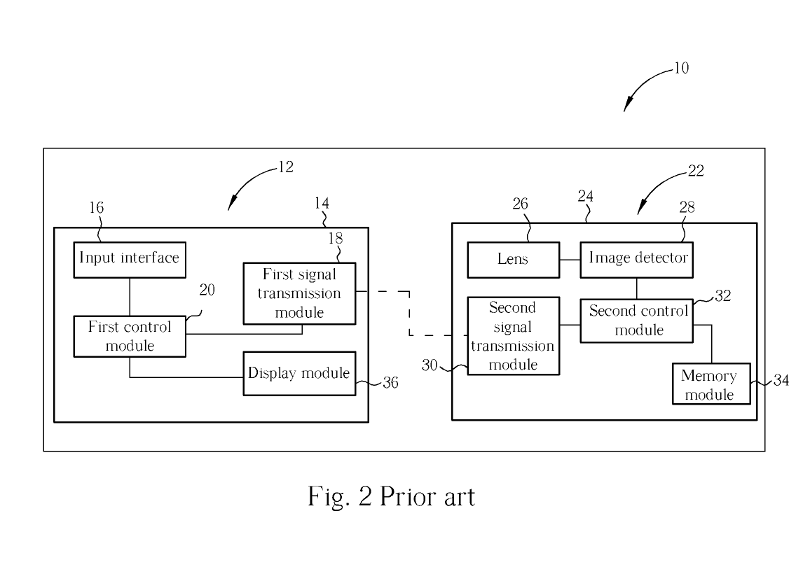

FIG. 3 illustrates an external view of an image capturing apparatus according to the present invention.

FIG. 4 illustrates a functional block diagram of an image capturing apparatus according to the present invention.

FIG. 5 illustrates a diagram of a stand combining with a motor according to the present invention.

FIG. 6 illustrates a flowchart of an image capturing apparatus performing a photo shoot according to the present invention.

### DETAILED DESCRIPTION

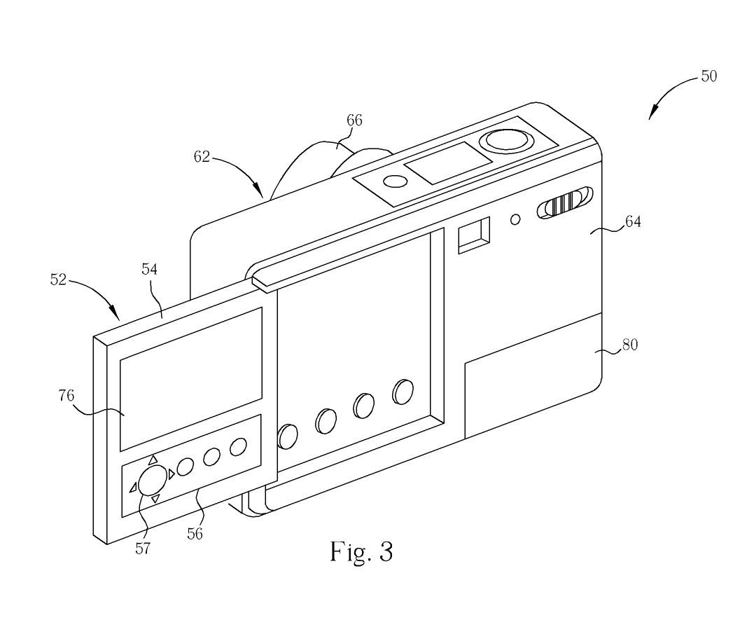

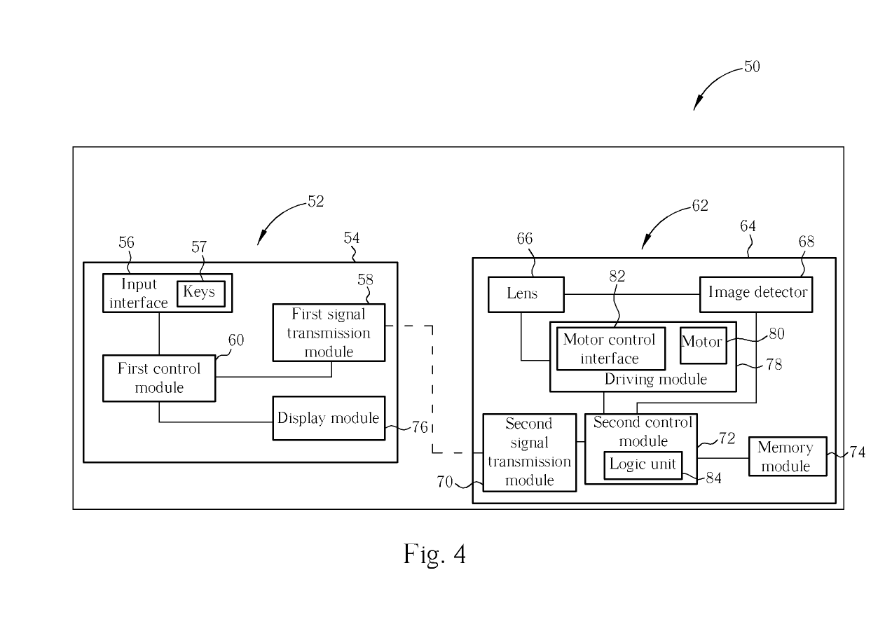

Please refer to FIG. 3 and FIG. 4. FIG. 3 illustrates an external view of an image capturing apparatus 50 according to the present invention. FIG. 4 illustrates a functional block diagram of an image capturing apparatus 50 according to the present invention. The image capturing apparatus 50 can be a digital camera or a digital camcorder. The image capturing apparatus 50 includes a remote controller 52 and an image capturing device 62. The remote controller 52 includes a first housing 54, an input interface 56 installed on the first housing 54 for inputting a remote control instruction. The input interface 56 has a plurality of buttons 57 for inputting the remote control instruction to control a shoot angle of a lens 66 of the image capturing device 62. The remote controller 52 further includes a first signal transmission module 58 installed within the first housing 54 for outputting a remote control signal, and a first control module 60 installed within the first housing 54 for controlling the first signal transmission module 58 to output the corresponding remote control signal when the input interface 56 receives the remote control instruction.

The image capturing device 62 which is a main component of the image capturing apparatus 50 for performing the function of taking pictures. The image capturing device 62 includes a second housing 64, a lens 66 installed within the second housing 64 for capturing the light signals of an image, an image detector 68 for converting the light signals into the electric signals. If there are more light accepted pixels, then the resolution of the taken picture will be higher. The image detector 68 can include a plurality of charge coupled devices (CCDs) or a plurality of complementary metal-oxide semi-conductors (CMOSs). The image capturing device 62 further includes a second signal transmission module 70 installed within the second housing 64 for receiving the remote control signal transmitted from the first signal transmission module 58 of the remote controller 52, and a second control module 72 installed within the second housing 64 which can be a digital signal processor for processing taken image signals. The second control module 72 can control the operations of the image capturing device 62 according to the remote control signal transmitted from the first signal transmission module 58 to the second signal transmission module 70. Furthermore, the image capturing device 62 includes a memory module 74 which can be a flash memory such as a CF card and an SD card, and a read-only memory such as a compact disc and a mini hard-disk for storing the taken pictures.

Furthermore, the remote controller 52 further includes a display module 76 installed on the first housing 54 and electrically connected to the first control module 60, wherein the second control module 72 can control the second signal transmission module 70 to output the image signals to the first signal transmission module 58. The display module 76 is utilized for displaying the image signals received by the first signal transmission module 58. The display module 76 can be a TN-LCD, an STN-LCD, a TFT-LCD, an LTPS TFT-LCD and an OLED. The image capturing device 62 further includes a driving module 78 installed within the second housing 64 for driving the image capturing device 62 to adjust a shoot angle of the lens 66. The driving module 78 has a motor 80 and a motor control interface 82 electrically connected to the second control module 72 for controlling the movement of the motor 80 according to a control signal transmitted from the second control module 72 so as to rotate the lens 66. The second control module 72 has a logic unit 84 for controlling the driving module 78 to drive the image capturing device 62 to move to adjust the shoot angle of the lens 66 according to the remote control signal corresponding to the motion of the image capturing device 62 transmitted from the first signal transmission module 58 and received by the second signal transmission module 70. Furthermore, as shown in FIG. 3, the first housing 54 of the remote controller 52 is attached to the second housing 64 of the image capturing device 62 in a detachable manner, therefore, the user can remove the remote controller 52 from the image capturing device 62 when picture is required to be taken remotely, and when the remote controller 52 is not required, it can be retrieved back to the image capturing device 62.

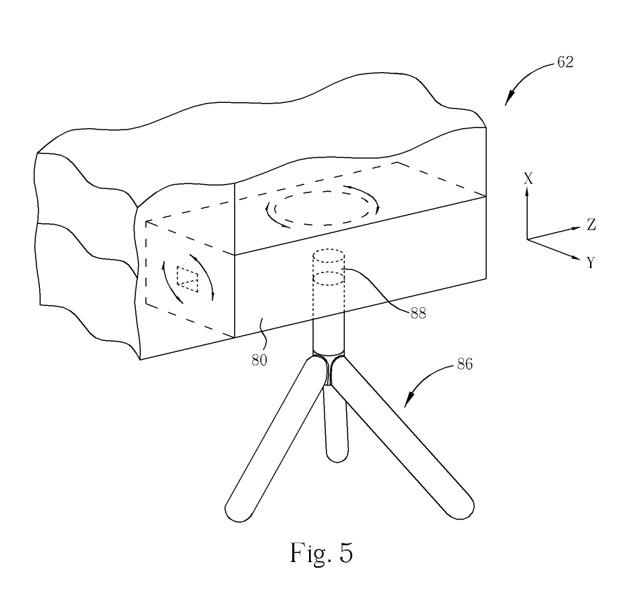

Please refer to FIG. 5. FIG. 5 illustrates a diagram of a stand 86 combining with a motor 80 according to the present invention. The motor 80 has a hole 88 for accepting the stand 86. The internal portion of the motor 80 has a rotating axis so that the connection point of the hole 88 and the stand 86 can be a pivot for the image capturing device 62, and the image capturing device 62 is capable of rotating in the directions of the X axis and the Z axis as shown in FIG. 5. Therefore, when the image capturing device 62 rotates in the directions of the X axis and the z axis, a panning angle and a tilting angle of the lens 66 can be adjusted respectively. The installation position of the motor 80 installed within the image capturing device 62 is not limited to what is shown in FIG. 5, as long as the image capturing device 62 can rotate with respect to the stand 86 so as to adjust the shoot angle.

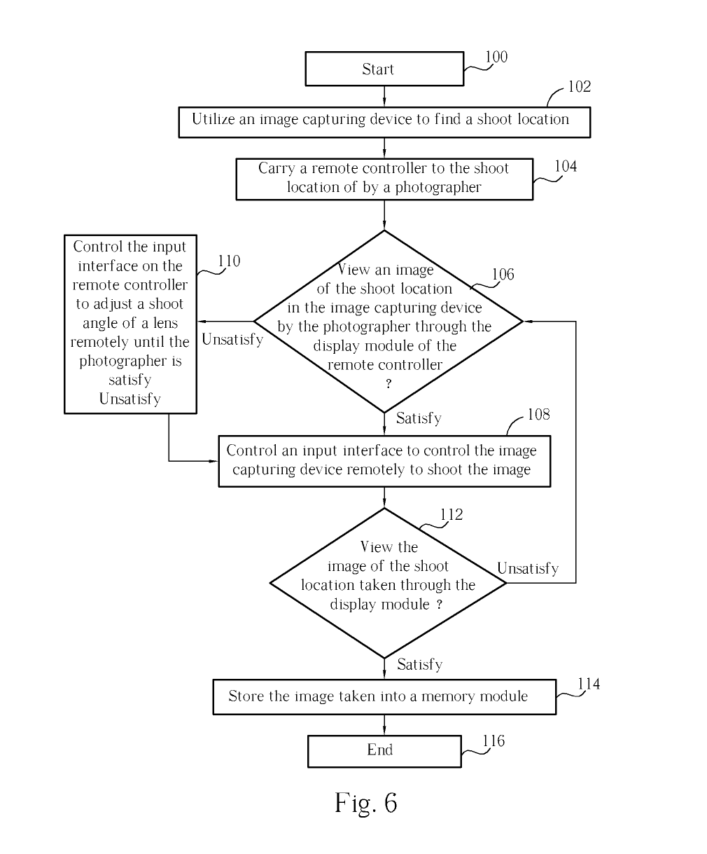

Please refer to FIG. 6. FIG. 6 illustrates a flowchart of an image capturing apparatus 50 performing a photo shoot according to the present invention. The photo shooting method includes the following steps:

Step 100: Start;

Step 102: Utilize an image capturing device 62 to find a shoot location;

Step 104: Carry a remote controller 52 to the shoot location by a photographer;

Step 106: View an image of the shoot location in the image capturing device 62 by the photographer through the display module 76 of the remote controller 52, if satisfy with the image in the image capturing device 62, execute step 108; if not satisfy with the image in the image capturing device 62, execute step 110;

Step 108: Shoot the image by the photographer controlling an input interface 56 on the remote controller 52 to control the image capturing device 62 remotely, execute to step 112;

Step 110: View the image of the shoot location in the image capturing device 62 through the display module 76 of the remote controller 52 by the photographer, and at the same time, control the input interface 56 on the remote controller 52 to control the motion of the image capturing device 62 remotely to adjust a shoot angle of a lens 66 until the photographer is satisfied, execute to step 108;

Step 112: View the taken image of the shoot location in the image capturing device 62 through the display module 76 of the remote controller 52 by the photographer, if satisfy with taken image, execute step 114; if not satisfy with the taken image in the image capturing device 62 discard image and execute step 106 again;

Step 114: Store the taken image in the image capturing device 62 into a memory module 74;

Step 116: End.

The above-mentioned steps will be further explained. When the photographer wants to perform a photo shoot utilizing the image capturing apparatus 50, especially when installing the image capturing device 62 on the stand 86 and utilizing the remote controller 52 at a remote end to take photos, the photographer can first setup the image capturing device 62 and the stand 86 to find a shoot location, then the photographer can carry the remote controller 52 to the location where the photo is to be taken. The photographer can view an image of the shoot location in the image capturing device 62 through the display module 76 of the remote controller 52, which means that the second control module 72 of the image capturing device 62 can control the second signal transmission module 70 to output the light signals of the image captured by the lens 66, and the light signals is converted to electric signals corresponding to the image signal via an image detector 68 to the first signal transmission module 58, the signal transmission method between the first signal transmission module 58 and the second signal transmission module 70 can be a wireless transmission, for example utilizing wireless network protocol transmission signals of IEEE 802.11b, wireless network protocol transmission signals of Bluetooth or infrared transmission signals. And the first control module 60 can control the display module 76 to display corresponding image data according to the image signals received by the first signal transmission module 58, in this way the photographer can view the present image captured by the lens 66 of the image capturing device 62 via the remote controller 52 end, the present image being the status of the photographer located within the shoot location.

In the following, when the photographer is viewing the image of the shoot location in the image capturing device 62 through the display module 76 of the remote controller 52, if the photographer is satisfied with the image in the image capturing device 62, the photographer can control the input interface 56 on the remote controller 52 to control the image capturing device 62 remotely to shoot the photo, which means that the remote control instruction corresponding to a camera shutter of the image capturing device 62 can be inputted via the input interface 56, the first control module 60 then can control the first signal transmission module 58 to output the corresponding remote control signal to the second signal transmission module 70 of the image capturing device 62 after the remote control instruction is received from the input interface to activate the camera shutter of the image capturing device 62. After receiving the corresponding remote control signal transmitted from the second signal transmission module 70, the second control module 72 will activate the camera shutter to shoot, at this time, the image detector 68 will convert the light signals captured by the lens 66 into electric signals to be transmitted to the second control module 72, the second control module 72 will then transmit image signals corresponding to the electric signals to the second signal transmission module 70 and the second control module 72 will control the second signal transmission module 70 to output the image signals corresponding to the electric signals to the first signal transmission module 58, lastly the first control module 60 can control the display module 76 to display the corresponding image data according to the image signals corresponding to the electric signals received by the first signal transmission module 58, hence the photographer can view the image data of the shoot taken through the remote controller 52 end.

On the contrary, if the photographer is not satisfied with the image of the shoot location, the photographer can view the image of the shoot location in the image capturing device 62 through the display module 76 of the remote controller 52. At the same time, the photographer can control buttons 57 of the input interface 56 on the remote controller 52 to input the remote control signal to control the image capturing device 62 to move remotely so as to adjust a shoot angle of a lens 66. After receiving the remote control instruction transmitted from the input interface 56 to control the motion direction of the image capturing device 62, the first control module 60 then can control the first signal transmission module 58 to output the corresponding remote control signal to the second signal transmission module 70 of the image capturing device 62. And after receiving the corresponding remote control signal transmitted from the second signal transmission module 70, a logic unit 84 of the second control module 72 will then output a corresponding control signal to a motor control interface 82 of the driving module 78 to drive the corresponding action of the motor 80; and the motor 80 can drive the image capturing device 62 to rotate with respect to the fixed stand 86. In this way, the shoot angle of the lens 66 can also be adjusted accordingly, and the image capturing device 62 will keep transmitting image data of the shoot location via the second signal transmission module 70. While the photographer is adjusting the shoot angle of the lens 66 remotely, at the same time, the photographer can also return to view the image of the shoot location after the shoot angle has been adjusted on the display module 76 of the remote controller 52. When the photographer is satisfied with the new image of the shoot location, the photographer can control the input interface 56 on the remote controller 52 to control the image capturing device 62 to shoot image remotely, the following action will be similar to the previously mentioned, therefore will not be further mentioned.

When the photographer views the taken image data on the remote controller 52 and is satisfied with the taken image data, the photographer can control the input interface 56 on the remote controller 52 to control the image capturing device 62 remotely to store the image taken into the memory module 74, which means that the remote control instruction corresponding to the image stored can be stored by the input interface 56. After receiving the remote control instruction of the image stored transmitted by the remote control instruction, the first control module 60 then can control the first signal transmission module 58 to output the corresponding remote control signal to the second signal transmission module 70 of the image capturing device 62. And after receiving the corresponding remote control signal transmitted from the second signal transmission module 70, the second control module 72 will store the taken image into the memory module 74, hence completes the photo shoot process. But if the photographer is not satisfied with the image taken by the image capturing device 62, then the photographer can discard the image taken and proceed with the process of shoot location to execute another photo shoot.

The above-mentioned embodiment explains that the image capturing apparatus 50 can be remote controlled through the remote controller 52 to adjust the shoot angle of the lens. After ensuring the present image of the shoot location in the image capturing device 62, the image capturing device 62 can be remote controlled by the photographer through the remote controller 52 to begin a photo shoot. Therefore, the operation of the image capturing apparatus 50 can be the actions of utilizing a digital camera or a digital video camera. The present invention can also be applied on the digital video camera or the digital camera that is capable of filming short video clips, therefore, the shoot angle of the image capturing device 62 can be remote controlled by the remote controller 52 which is controlled by the user. At the same time, the user can record video to achieve the effect of shooting video and adjusting shoot angle simultaneously.

In comparison to the conventional image capturing apparatus, the image capturing apparatus of the present invention is capable of utilizing the remote controller to control the image capturing device remotely to adjust the shoot angle of the lens. Therefore, the user is not required to take numerous trips between the shoot location and the image capturing device for adjusting the required angle of the shoot location in the image capturing device, which means that the user can complete the adjustment of the required shoot angle and also the user can perform shooting at the shoot location end. Thus, the application of the present invention offers great convenience to remote controlled photo shooting.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image capturing apparatus, comprising:
a remote controller, comprising:
a first housing;
an input interface installed on the first housing for inputting a remote control instruction;
a first signal transmission module installed within the first housing for outputting a remote control signal; and
a first control module installed within the first housing for controlling the first signal transmission module to output the remote control signal when the input interface receives the remote control instruction; and
an image capturing device, comprising:
a second housing;
a lens installed within the second housing for capturing an image;
a second signal transmission module installed within the second housing for receiving the remote control signal transmitted from the first signal transmission module of the remote controller;
a driving module installed within the second housing for driving the image capturing device to adjust a shoot angle of the lens; and
a second control module installed within the second housing for controlling operation of the image capturing device according to the remote control signal transmitted from the first signal transmission module and received by the second signal transmission module, wherein the second control module comprises a logic unit for controlling the driving module to drive the image capturing device to move so as to adjust the shoot angle of the lens when the second signal transmission module receives the remote control signal from the first signal transmission module.

2. The image capturing apparatus of claim 1, wherein the remote controller further comprises a display module installed on the first housing and electrically connected to the first control module, the second control module controls the second signal transmission module to output an image signal to the first signal transmission module, and the display module displays the image signal received by the first signal transmission module.

3. The image capturing apparatus of claim 1, wherein the input interface of the remote controller comprises a plurality of buttons for inputting the remote control instruction to control a motion direction of the image capturing device.

4. The image capturing apparatus of claim 1, wherein the driving module comprises a motor and a motor control interface electrically connected to the second control module for controlling the motor according to a control signal transmitted from the second control module.

5. The image capturing apparatus of claim 4, wherein the motor comprises a hole for accepting a stand.

6. The image capturing apparatus of claim 1, wherein the first signal transmission module and the second signal transmission module transmit in a wireless manner.

7. The image capturing apparatus of claim 6, wherein the first signal transmission module and the second signal transmission module utilize wireless network protocol transmission signals compliant with the IEEE 802.11b standard.

8. The image capturing apparatus of claim 6, wherein the first signal transmission module and the second signal transmission module utilize wireless network protocol transmission signals compliant with the Bluetooth standard.

9. The image capturing apparatus of claim 6, wherein the first signal transmission module and the second signal transmission module utilize infrared transmission signals.

10. The image capturing apparatus of claim 1, wherein the first housing of the remote controller is attached to the second housing of the image capturing device in a detachable manner.

11. The image capturing apparatus of claim 1, wherein the image capturing apparatus is a digital camera.

12. The image capturing apparatus of claim 1, wherein the image capturing apparatus is a digital camcorder.

13. A remote controller, comprising:
a first housing;
an input interface installed on the first housing for inputting a remote control instruction;
a signal transmission module installed within the first housing for outputting a remote control signal; and
a control module installed within the first housing for controlling the signal transmission module to output the remote control signal to control an image capturing device when the input interface receives the remote control instruction, wherein the image capturing device couples to the remote controller, and the control module comprises a logic unit for outputting the remote control signal to control a driving module of the image capturing device to drive the image capturing device to move.

14. The remote controller of claim 13, wherein the remote controller further comprises a display module installed on the first housing and electrically connected to the control module for displaying an image signal received by the signal transmission module.

15. The remote controller of claim 13, wherein the input interface comprises a plurality of buttons for inputting the remote control instruction to control a motion direction of the image capturing device.

16. The remote controller of claim 13, wherein the signal transmission module transmits in a wireless manner.

17. The remote controller of claim 13, wherein the first housing is attached to a second housing of the image capturing device in a detachable manner.

18. An image capturing device, comprising:
a housing;
a lens installed within the housing for capturing an image;
a signal transmission module installed within the housing for receiving a remote control signal in a wireless manner;
a driving module installed within the housing for driving the image capturing device to adjust a shoot angle of the lens; and
a control module installed within the housing for controlling operation of the image capturing device according to the remote control signal received by the signal transmission module, wherein the control module comprises a logic unit for controlling the driving module to drive the image capturing device to move so as to adjust the shoot angle of the lens when the signal transmission module receives the remote control signal.

19. The image capturing device of claim 18, wherein the driving module comprises a motor and a motor control interface electrically connected to the control module for controlling the motor according to a control signal transmitted from the control module.

20. The image capturing device of claim 19, wherein the motor comprises a hole for accepting a stand.
